(19) United States
(12) Patent Application Publication
(10) Pub. No.: US 2006/0274021 A1
(43) Pub. Date: Dec. 7, 2006

(54) Display device

(75) Inventors: Dae-Jin Park, Incheon-si (KR); Jae-Hyuk Chang, Seoul (KR); Hyung-Il Jeon, Incheon-si (KR); Jong-Hwan Lee, Anyang-si (KR); Do-Gi Lim, Chungcheongnam-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/449,114

(22) Filed: Jun. 7, 2006

(30) Foreign Application Priority Data
Jun. 7, 2005 (KR) 10-2005-0048299
Aug. 16, 2005 (KR) 10-2005-0074963

(51) Int. Cl. G09G 3/36

(52) U.S. Cl. 345/100

(57) ABSTRACT

The present invention relates to a display device, and more particularly to a display device in which gate lines and a main gate driver can be repaired. The display device includes a plurality of pixels respectively including a switching element, a gate line connected to the switching element, and first and second gate drivers respectively including a plurality of stages that are interconnected and sequentially generate output signals. Any one of the stages of the first gate driver and any one of the stages of the second gate driver are connected to the same gate line. In this manner, gate drivers that generate the same output are disposed in one gate line on the left and right sides. It is therefore possible to repair disconnected gate lines without using a laser.

### CROSS-REFERENCE TO RELATED APPLICATION

This application claims priority to and the benefit of Korean Patent Application No. 10-2005-0048299 and 10-2005-0074963 respectively filed in the Korean Intellectual Property Office on Jun. 7, 2005, and Aug. 16, 2005, the contents of which are incorporated herein by reference.

### FIELD OF THE INVENTION

The present invention relates to a display device.

### DESCRIPTION OF THE RELATED ART

Flat panel displays, such as organic light emitting diode (OLED) displays, plasma display panels (PDP), and liquid crystal displays (LCD) have been actively developed instead of a cathode ray tube (CRT) which is heavy and bulky. The PDP displays characters and/or images by employing plasma generated by gas discharge. The OLED display displays characters and/or images by employing the electric field emitted by specific organic matter or polymers. The liquid crystal display displays images by applying an electric field to a liquid crystal layer between two display panels and controlling the intensity of the electric field, thereby controlling the transmittance of light passing through the liquid crystal layer.

A dual display device which is used for mobile phones, etc., includes an internal main display panel unit and an externally mounted sub-display panel. A flexible printed circuit (FPC) film receives an externally input signal and a sub-FPC connects the main display panel and the sub-display panel unit all controlled by an integrated chip. Each of the aforementioned devices include a display panel and a great number of pixels each having a switching element and a display signal line, a gate driver and a data driver. An integrated chip for controlling the gate driver and the data driver of the main display panel unit and the sub-display panel unit is generally mounted in the main display panel unit in a chip-on-glass (COG) form. The gate driver includes a plurality of shift register stages that are interconnected and arranged in a row.

To correct manufacturing defects such as disconnected signal lines, etc., a plurality of repair lines are disposed in the peripheral area outside the display area that are connected to the left and right sides of the disconnected gate lines and a gate signal is applied to the repair lines. A magnifying lens must be used to find disconnected lines after which a laser is used to repair the disconnected portions. In addition, the number of repair lines that may be disposed in the peripheral area is limited, which makes it impossible to repair multiple disconnections. However a defect in any of the transistors it is not easy to repair.

### SUMMARY OF THE INVENTION

The present invention provides a display device in which gate lines can be repaired without using a laser and in which a main gate driver can be repaired using a sub-gate driver. The first stages of a first gate driver and the second stages of a second gate driver are connected to the same gate line with a switching element therebetween so that if any one of the first stages is a defective so that cannot generate an output, the second stage connected to the defective stage through the same gate line generates an output.

### BRIEF DESCRIPTION OF THE DRAWINGS

The foregoing objects and features may become more apparent from a reading of the ensuing description together with the drawing, in which:

FIG. 1 is a schematic diagram of a liquid crystal display according to an exemplary embodiment of the present invention.

FIG. 2 is a block diagram of the liquid crystal display according to an exemplary embodiment of the present invention.

FIG. 3 is an equivalent circuit diagram illustrating one pixel of the liquid crystal display according to an exemplary embodiment of the present invention.

FIG. 4 is a block diagram of a gate driver according to an exemplary embodiment of the present invention.

FIG. 5 is an exemplary circuit diagram of a j-th stage of a shift register for the gate driver shown in FIG. 4.

FIG. 6 is a signal waveform diagram of the gate driver shown in FIG. 4.

FIG. 7 is a block diagram of a gate driver according to another exemplary embodiment of the present invention.

FIG. 8 is a view illustrating an example in which the gate driver is repaired in the block diagram shown in FIG. 7.

### DETAILED DESCRIPTION OF THE EMBODIMENTS

The thicknesses of the layers are enlarged in the drawings. Like reference numerals designate like elements throughout the specification. When it is said that any part, such as a layer, film, area, or plate, is positioned on another part, it means the part is directly on the other part or above the other part with at least one intermediate part. On the other hand, if any part is said to be positioned directly on another part it means that there is no intermediate part between the two parts.

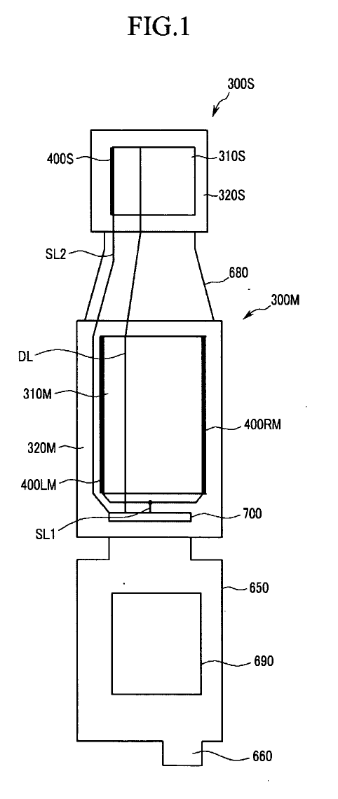

In FIG. 1, unless otherwise mentioned, gate driver 400 may be a gate driver 400RM, a gate driver 400LM, or a gate driver 400S. The display device includes a main display panel unit 300M and a sub-display panel unit 300S, an FPC 650 attached to the main display panel unit 300M, a sub-FPC 680 attached between the main display panel unit 300M and the sub-display panel unit 300S, and an integration chip 700 mounted on the display panel unit 300M.

FPC 650 is attached near one side of the main display panel unit 300M. Furthermore, the FPC 650 has an opening 690 that exposes a part of the main display panel unit 300M when the FPC 650 is folded. An input section 660 to which an external signal is input is disposed under the opening 690. The FPC 650 further includes a plurality of signal lines (not shown) for electrically connecting other portions of the input section 660 and the integration chip 700, and the integration chip 700 and the main display panel unit 300M. These signal lines have a wide width at a point where they are connected to the integration chip 700 and a point where they are attached to the main display panel unit 300M, thereby forming pads (not shown).

Sub-FPC 680 is attached between the other side of the main display panel unit 300M and one side of the sub-display panel unit 300S, and includes signal lines SL2 and DL for electrically connecting the integration chip 700 and the sub-display panel unit 300S. Display panel unit 300M includes a display area 310M forming the screen, and a peripheral area 320M. The peripheral area 320M may include a light-shielding layer (not shown) (“black matrix”) for shielding light. Furthermore, the display panel unit 300S includes a display area 310S forming the screen, and a peripheral area 320S. The peripheral area 320S may include a light-shielding layer (not shown) (“black matrix”) for shielding light. The FPC 650 and the sub-FPC 680 are attached to the peripheral areas 320M and 320S.

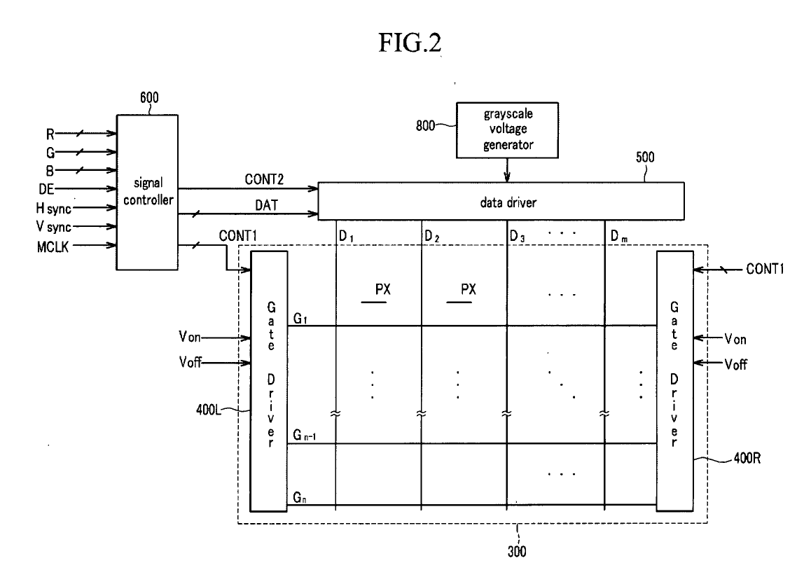

As shown in FIG. 2, each of the display panel units 300M and 300S includes a plurality of display signal lines having a plurality of gate lines G₁-Gₙ and a plurality of data lines D₁-Dₘ, a plurality of pixels PX that are connected to the gate lines and the data lines and are arranged approximately in a matrix form, and a gate driver 400 that supplies signals to the gate lines G₁-Gₙ. Most of the pixels PX and the display signal lines G₁-Gₙ nd D₁-Dₘ are located within the display areas 310M and 310S. The gate drivers 400M and 400S are located in the peripheral areas 320M and 320S. The peripheral areas 320M and 320S on the side where the gate drivers 400M and 400S are located have a little larger width.

As shown in FIG. 1, a portion of the data lines D₁-Dₘ of the main display panel unit 300M are connected to the sub-display panel unit 300S through the sub-FPC 680. That is, the two display panel units 300M and 300S share a part of the data lines D₁-Dₘ. One of the data lines is shown as DL in FIG. 1. Upper panel 200 is smaller than a lower panel 100, and a part of the region of the lower panel 100 is accordingly exposed. The data lines D₁-Dₘ extend up to the region and are then connected to a data driver 500. The gate lines G₁-Gₙ also extend up to regions covered with the peripheral areas 320M and 320S and are then connected to the gate drivers 400RM, 400LM, and 400S.

The display signal lines G₁-Gₙ and D₁-Dₘ have a wide width at points where they are connected to the FPCs 650 and 680, thus forming pads (not shown). The display panel units 300M and 300S and the FPCs 650 and 680 are adhered by an anisotropically conductive layer (not shown) for electrically connecting the pads. Each pixel PX (for example, a pixel PX connected to an i-th (i=1, 2, . . . , n) gate line Gᵢ and a j-th (j=1, 2, . . . , m) data line Dⱼ) includes a switching element Q connected to the signal lines Gᵢ and Dⱼ, and a liquid crystal capacitor Clc and a storage capacitor Cst connected to the switching element Q. The storage capacitor Cst may be omitted, if appropriate.

The switching element Q may be a three-terminal element provided in the lower panel 100, such as a thin film transistor. The switching element Q has a control terminal connected to the gate line Gᵢ, an input terminal connected to the data line Dⱼ, and an output terminal connected to the liquid crystal capacitor Clc and the storage capacitor Cst. The liquid crystal capacitor Clc uses a pixel electrode 191 of the lower panel 100 and a common electrode 270 of the upper panel 200 as two terminals. A liquid crystal layer 3 between the two electrodes 191 and 270 functions as a dielectric material. The pixel electrode 191 is connected to the switching element Q. The common electrode 270 is formed on the entire surface of the upper panel 200 and receives a common voltage Vcom. Unlike as shown in FIG. 2, the common electrode 270 may be provided in the lower panel 100. In this case, at least one of the two electrodes 191 and 270 may have a linear or bar shape.

The storage capacitor Cst, which serves to assist the liquid crystal capacitor Clc, includes an additional signal line (not shown) provided in the lower panel 100 and the pixel electrode 191, which are overlapped with an insulator therebetween. Common voltage Vcom is applied to the additional signal line. In the storage capacitor Cst, however, the pixel electrode 191 may be overlapped with an immediately upper previous gate line through the intermediation of the insulator.

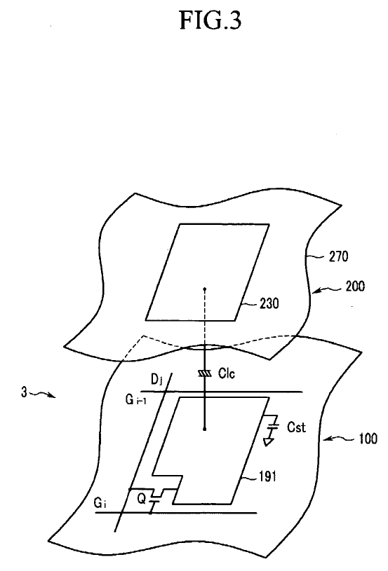

In order to implement color display, each pixel PX may display one of the primary colors uniquely (spatial division), or each pixel PX may display the primary colors alternately (temporal division) according to time, so that desired colors can be recognized through the spatial and temporal sum of the primary colors. An example of the primary colors may include three primary colors such as red, green, and blue. FIG. 3 shows an example in which each pixel PX has a color filter 230 that represents one of the primary colors on the region of the upper panel 200 corresponding to the pixel electrode 191, as an example of spatial division. Unlike as shown in FIG. 3, the color filter 230 may be formed on or below the pixel electrode 191 of the lower panel 100. At least one polarizer (not shown) that polarizes light is attached outside the liquid crystal panel assembly 300.

A grayscale voltage generator 800 generates two sets of grayscale voltages (or reference grayscale voltages) which are related to the transmittance of the pixel PX. One of the two sets has a positive value with respect to the common voltage Vcom, and the other of the two sets has a negative value with respect to the common voltage Vcom.

Gate drivers 400RM, 400LM, and 400S are connected to gate lines G₁-Gₙ, and apply a gate signal having a combination of a gate-on voltage Von, which can turn on the switching element Q, and a gate-off voltage Voff, which can turn off the switching element Q. Gate drivers 400RM, 400LM, and 400S are advantageously formed and integrated using the same process as that of the switching element Q of the pixel, and are connected to the integration chip 700 through the signal lines SL1 and SL2. Gate drivers 400RM and 400LM are disposed on the right and left sides, respectively, of the main display panel unit 300M and are connected to the same gate lines G1-Gn. Gate drivers 400RM and 400LM perform the same operation according to the same signal from the integration chip 700. In the sub-display panel 300S, gate driver 400S may also be disposed on the right side.

A data driver 500 is connected to the data lines D₁-Dₘ of the liquid crystal panel assembly 300. The data driver 500 selects a grayscale voltage output from the grayscale voltage generator 800 and applies it to the data lines D₁-Dₘ as a data signal. However, in the case where the grayscale voltage generator 800 does not provide voltages for the entire grayscale but provides only a predetermined number of reference grayscale voltages, the data driver 500 divides the reference grayscale voltages to generate grayscale voltages for all the grayscales and selects a data signal from the generated grayscale voltages.

A signal controller 600 controls the gate driver 400, the data driver 500, and so on. The integration chip 700 receives an external signal through the input section 660 and the signal lines provided in the FPC 650, and provides the processed signals to the main display panel unit 300M and the sub-display panel unit 300S through the peripheral area 320M of the main display panel unit 300M and wiring provided in the sub-FPC 680, thereby controlling the main display panel unit 300M and the sub-display panel unit 300S. The integration chip 700 includes the grayscale voltage generator 800, the data driver 500, the signal controller 600, and so on, which are shown in FIG. 2.

The display operation of the liquid crystal display constructed as above will be described below in detail. Signal controller 600 receives input image signals R, G, and B from an external graphics controller (not shown), and input control signals for controlling the display of the signals. Examples of the input control signals may include a vertical synchronization signal Vsync, a horizontal synchronizing signal Hsync, a main clock signal MCLK, a data enable signal DE, and so on. Signal controller 600 processes the input image signals R, G, and B based on the input image signals R, G, and B and the input control signals in such a way as to be suitable for operating conditions of the liquid crystal panel assembly 300, generates a gate control signal CONT1, a data control signal CONT2, etc., transmits the gate control signal CONT1 to the gate driver 400, and transmits the data control signal CONT2 and a processed image signal DAT to the data driver 500.

Gate control signal CONT1 includes a scanning start signal STV indicating the scanning start, and at least one clock signal to control the output cycle of the gate-on voltage Von. The gate control signal CONT1 may further include an output enable signal (OE) to define the sustain period of the gate-on voltage Von. Data control signal CONT2 includes a horizontal synchronization start signal STH, which informs the pixel PX of one row of the start of transmission of image data, and a load signal LOAD and a data clock signal HCLK to instruct a data signal to be applied to the data lines D₁-Dₘ. The data control signal CONT2 may further include an inversion signal RVS for inverting a voltage polarity of the data signal for the common voltage Vcom (hereinafter, “the voltage polarity of the data signal for the common voltage” will be abbreviated to “the polarity of the data signal”).

Data driver 500 receives the digital image signal DAT with respect to the pixel PX of one row in response to the data control signal CONT2 from the signal controller 600, selects a grayscale voltage corresponding to each digital image signal DAT, converts the digital image signal DAT into an analog data signal, and then applies the converted signal to corresponding data lines D₁-Dₘ. Gate driver 400 applies the gate-on voltage Von to the gate lines G₁-Gₙ in response to the gate control signal CONT1 from the signal controller 600, thereby turning on the switching element Q connected to the gate lines G₁-Gₙ. Accordingly, the data signal applied to the data lines D₁-Dₘ is applied to a corresponding pixel PX through the turned-on switching element Q.

The difference between the voltage of the data signal applied to the pixel PX and the common voltage Vcom appears as a charge voltage of the liquid crystal capacitor Clc, i.e., a pixel voltage. Liquid crystal molecules are oriented according to the amount of the pixel voltage, and the polarization of light passing through the liquid crystal layer 3 is changed accordingly. Variation in such polarization appears as variation in the transmittance of light by means of the polarizer attached to the display panel assembly 300.

These processes are repeated each horizontal period (this is also referred to as “1H”, the same as one cycle of the horizontal synchronizing signal Hsync and the data enable signal DE), the gate-on voltage Von is applied sequentially to all the gate lines G₁-Gₙ and the data signal is applied to all the pixels PX, thereby displaying an image of one frame. When one frame is finished, the next frame begins and the state of the inversion signal RVS applied to the data driver 500 is controlled (“frame inversion”) such that the polarity of the data signal applied to each pixel PX becomes opposite to that in the previous frame. At this time, the polarity of the data signal flowing through one data line may be changed (for example: row inversion, dot inversion) or the polarity of the data signal applied to one pixel row may be different (for example: column inversion, dot inversion) depending on a characteristic of the inversion signal RVS even within one frame.

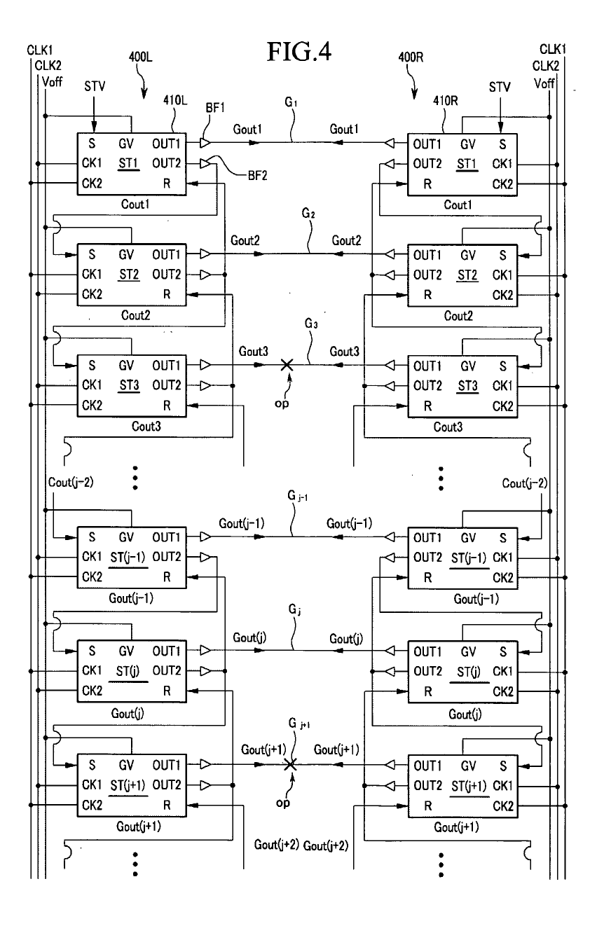

The display device according to an exemplary embodiment of the present invention will be described below in detail with reference to FIGS. 4 to 6. Gate drivers 400L and 400R shown in FIG. 4 are arranged in series on the left and right sides, and are shift registers including a plurality of stages 410L and 410R, respectively, which are connected to the gate lines G₁-Gₙ. The scanning start signal STV, the plurality of clock signals CLK1 and CLK2, and the gate-off voltage Voff are input to the gate drivers 400L and 400R, respectively. Each of the stages 410L and 410R has a set terminal S, a gate voltage terminal GV, a pair of clock terminals CK1 and CK2, a reset terminal R, a gate output terminal OUT1, and a carry output terminal OUT2. The two output terminals OUT1 and OUT2 are connected to buffers BF1 and BF2, respectively.

To the set terminal S of each stage (for example, a j-th stage STj located on the left or right side) the input is the carry output of the previous stage ST(j−1) (i.e., a previous carry output Cout(j−1)), to the reset terminal R thereof is input a carry output of the later stage ST(j+1) (i.e., a later carry output Cout(j+1)), to the clock terminals CK1 and CK2 thereof is input the clock signals CLK1 and CLK2, and to the gate voltage terminal GV is input the gate-off voltage Voff. The two output terminals OUT1 and OUT2 output an output Gout(N) and a carry output Cout(N) through a gate buffer BUF and a carry buffer CARRY, respectively. The gate output Gout(j) is output to the gate lines G₁-Gₙ connected thereto. The carry output Cout(j) is output to the previous and later stages ST(j−1) and ST(j+1).

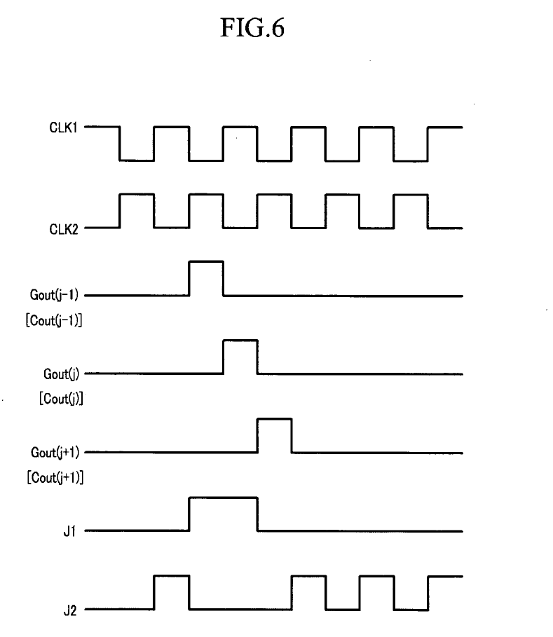

To the first stage, ST1, the scanning start signal STV is applied instead of the previous gate output. If a clock terminal CK1 of a j-th stage ST(j) is applied with the clock signal CLK1 and a clock terminal CK2 thereof is applied with the clock signal CLK2, clock terminals CK1 of (j−1)-th and (j+1)-th stages ST(j−1) and ST(j+1) adjacent to the j-th stage ST(j) are applied with the clock signal CLK2 and clock terminals CK2 thereof are applied with the clock signal CLK1. Each of the clock signals CLK1 and CLK2 may preferably be the same as the gate-on voltage Von when it has a voltage level of high, and may preferably be the same as the gate-off voltage Voff when it has a voltage level of low so that it can drive the switching element Q of the pixel. As shown in FIG. 6, each of the clock signals CLK1 and CLK2 may have a duty ratio of 50%, and the phase difference between the two clock signals CLK1 and CLK2 may be 180°.

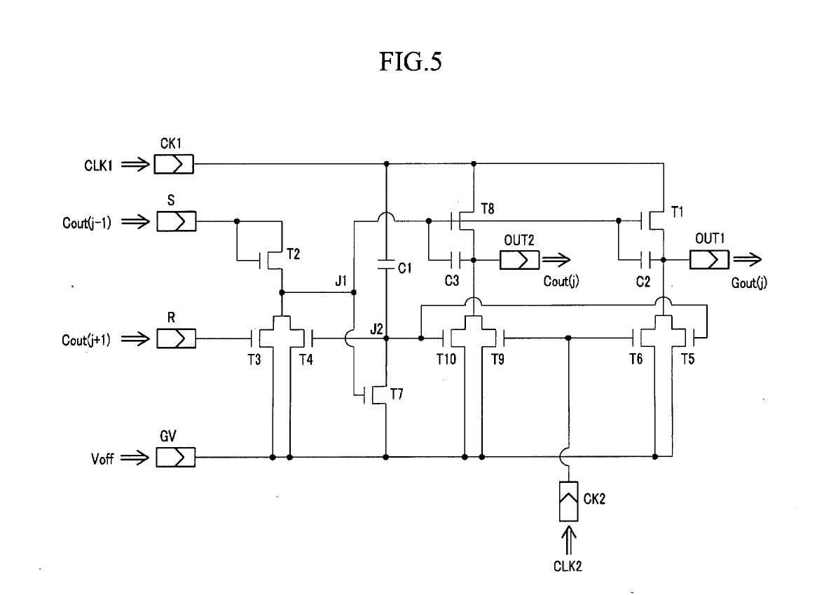

Referring to FIG. 5, each stage (for example, a j-th stage) of the gate driver 400 according to an exemplary embodiment of the present invention includes a plurality of NMOS transistors T1-T10 and capacitors C1-C3. It is however to be understood that PMOS transistors may be used instead of the NMOS transistors. Furthermore, capacitors C1-C3 may be parasitic capacitances between the gate and drain/source, which may be formed during a fabrication process.

Transistor T1 is connected between the clock terminal CK1 and the output terminal OUT1, and has a control terminal connected to a node J1. Transistor T2 has an input terminal and a control terminal commonly connected to the set terminal S and has an output terminal connected to the node J1. Transistors T3 and T4 are connected in parallel between the node J1 and the gate voltage terminal GV. Transistor T3 has a control terminal connected to the reset terminal R and transistor T4 has a control terminal connected to a node J2. Transistors T5 and T6 are connected in parallel between the output terminal OUT1 and the gate voltage terminal GV. Transistor T5 has a control terminal connected to the node J2 and transistor T6 has a control terminal connected to the clock terminal CK2. Transistor T7 is connected between the node J2 and the gate voltage terminal GV and has a control terminal connected to the node J1. Transistor T8 is connected between the clock terminal CK1 and the output terminal OUT2 and has a control terminal connected to the node J1. Transistors T9 and T10 are connected in parallel between the output terminal OUT2 and the gate voltage terminal GV. Transistor T9 has a control terminal connected to the clock terminal CK2 and transistor T10 has a control terminal connected to the node J2.

Capacitor C1 is connected between the clock terminal CK1 and the node J2, capacitor C2 is connected between the node J1 and the output terminal OUT1, and capacitor C3 is connected between the node J1 and the output terminal OUT2.

The operation of the stage constructed as above will be described below taking the j-th stage STj as an example. For ease of description, It will be assumed that a voltage corresponding to a high level of the clock signals CLK1 and CLK2 is a high voltage and the voltage corresponding to a low level of the clock signals CLK1 and CLK2 is the same as the gate-off voltage Voff, which will be referred to as a low voltage. If the clock signal CLK2 and the previous gate output Gout(j−1) are high, transistors T2, T6, and T9 are turned on. Transistor T2 transfers the high voltage to the node J1, thereby turning on transistor T7. Transistors T6 and T9 transfer the low voltage to the output terminals OUT1 and OUT2, respectively. Transistor T7 when turned on transfers the low voltage to the node J2. Transistors T1 and T8 then are turned on, so that the clock signal CLK1 is output to the output terminals OUT1 and OUT2. At this time, since the clock signal CLK1 is low, the gate output Gout(j) and the carry output Cout(j) go low. At the same time, capacitor C1 is not charged since it has the same voltage at both its ends, whereas capacitors C2 and C3 are charged to a voltage corresponding to the difference between the high and low voltage. At this time, since clock signal CLK1 and the later carry output Cout(j+1) are low and the node J2 is also low, transistors T3, T4, T5, and T10 whose control terminals are connected thereto stay turned off.

Thereafter, if the clock signal CLK2 and the previous carry output Cout(j−1) go low, transistors T6 and T9 and transistor T2 are turned off. Accordingly, the two capacitors C2 and C3 having one ends connected to the node J2 are floated and transistors T1 and T8 stay turned on accordingly. At this time, clock signal CLK1 goes high and the two output terminals OUT1 and OUT2 go high and the potential of the node J1 increases as much as the high voltage by means of capacitors C2 and C3. It has been shown in FIG. 6 that the potential of the node J1 is the same as a previous voltage. However, the potential is actually increased as much as the high voltage.

At this time, since the later carry output Cout(j+1) and the node J2 are low, transistors T5, T6, T9, and T10 also stay turned off. Therefore, the two output terminals OUT1 and OUT2 are connected only to the clock signal CLK1 and are isolated from the low voltage. Accordingly, the two output terminals OUT1 and OUT2 output the high voltage. On the other hand, capacitor C1 is charged to a voltage corresponding to a potential difference between both ends.

Thereafter, if the later carry output Cout(j+1) and the clock signal CLK2 become high and the clock signal CLK1 goes low, transistor T3 is turned on and transfers the low voltage to the node J1. Accordingly, transistor T7 having the control terminal connected to the node J1 is turned off and capacitor C1 becomes floated. Furthermore, the node J2 is kept to the low voltage (i.e., the previous voltage). At this time, since the clock signal CLK1 is low, a voltage at both ends of capacitor C1 becomes 0V.

At the same time, the connection of the two output terminals OUT1 and OUT2 to the clock signal CLK1 is disconnected since transistors T1 and T8 are turned off, whereas the two output terminals OUT1 and OUT2 are connected to the low voltage since transistors T6 and T9 are turned on, thereby outputting the low voltage. Thereafter, if the clock signal CLK1 goes high, the voltage at the other end (i.e., the node J2) of capacitor C1 shifts to the high voltage while the voltage at one end of capacitor C1 shifts to the high voltage. Accordingly, the voltage at both ends of capacitor C1 is kept at 0V. Therefore, since transistor T4 is turned on and transfers the low voltage to the node J1, the two transistors T1 and T8 stay turned off. Furthermore, since the two transistors T5 and T10 are turned on and transfer the low voltage to the two output terminals OUT1 and OUT2, respectively, the output terminals OUT1 and OUT2 continue to output the low voltage.

Subsequently, the voltage of node J1 maintains the low voltage until the previous carry output Cout(j−1) goes high. The voltage of the node J2 is synchronized with the clock signal CLK1 due to capacitor C1 and is thus changed. Accordingly, the output terminals OUT1 and OUT2 are connected to the low voltage through transistors T5 and T10 when the clock signal CLK1 is high and the clock signal CLK2 is low, and are connected to the low voltage through transistors T6 and T9 when the clock signal CLK1 is low and the clock signal CLK2 is high. In this manner, each of the stages 410L and 410R generates the gate output Gout(j) based on the previous carry output Cout(j−1) and the later carry output Cout(j+1) and in synchronization with the clock signals CLK1 and CLK2.

Referring back to FIG. 4, gate driver 400L located on the left side and the gate driver 400R located on the right side are symmetrical to each other. Each stage 410L of the gate driver 400L located on the left side is connected to the same gate lines G₁-Gⱼ₊₁ as those of each stage 410R of the gate driver 400R located on the right side. For example, it can be seen that if the third gate line G3 and the (j+1)-th gate line Gⱼ₊₁ are disconnected as shown in FIG. 4, the same signals are applied from the left and right sides of a disconnected portion op. Therefore, an additional step of repairing gate lines G₁-Gₙ (i.e., repair using a laser) is not required. Due to this, although a larger number of gate lines G₁-Gₙ than the number of repair lines are disconnected (for example, all the gate lines G₁-Gₙ are disconnected), they can be repaired. Therefore, time and cost required for the repair is saved and productivity is improved. Furthermore, where the substrate is formed using a material other than glass (for example, plastic), it is usually inconvenient to repair using laser irradiation. An embodiment of the present invention can solve this problem.

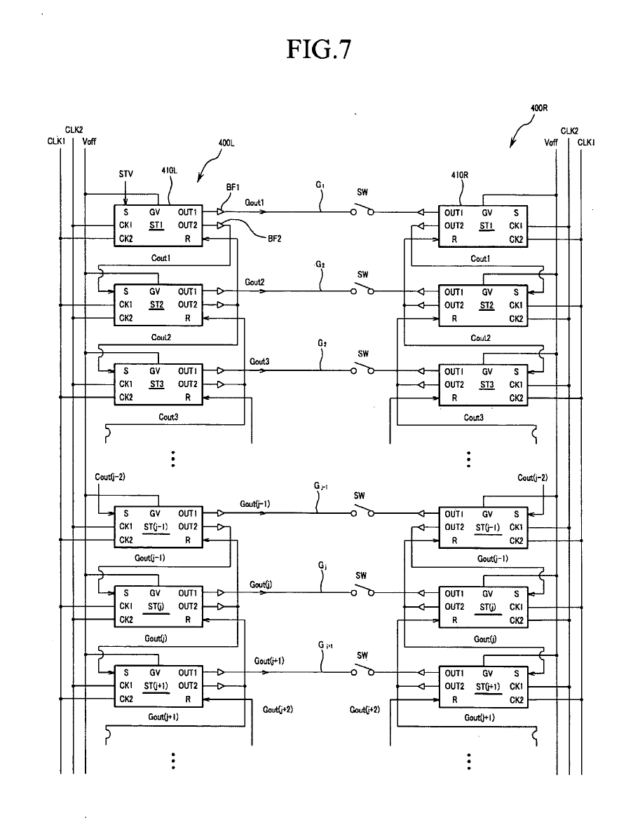

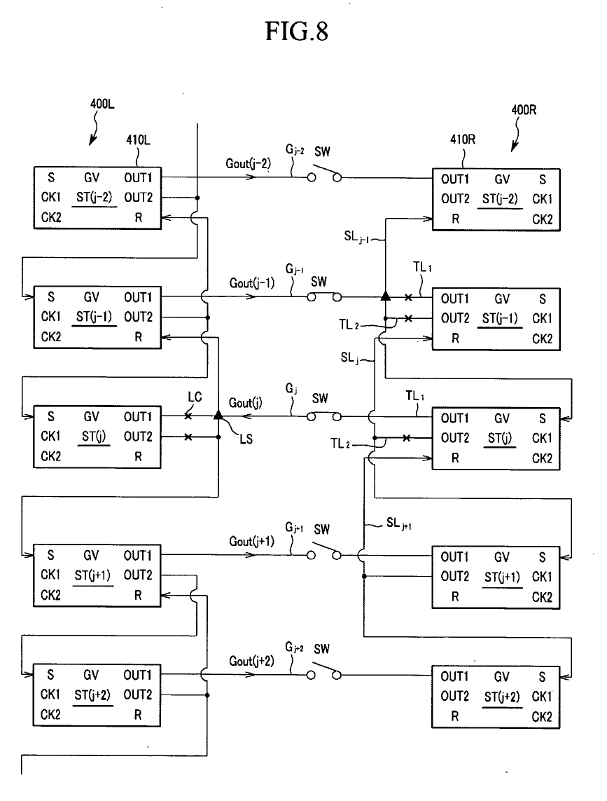

A display device according to another exemplary embodiment of the present invention will be described below in detail with reference to FIGS. 7 and 8. FIG. 7 is a block diagram of a gate driver according to another exemplary embodiment of the present invention, and FIG. 8 is a view illustrating an example in which the gate driver is repaired in the block diagram shown in FIG. 7. Gate drivers 400L and 400R shown in FIG. 7 are substantially the same as the gate drivers 400L and 400R shown in FIG. 4. In other words, the gate drivers 400L are 400R are arranged on the left and right sides and are shift registers including a plurality of stages 410L and 410R, respectively, which are connected to gate lines G₁-Gₙ. The gate drivers 400L and 400R are respectively applied with a scanning start signal STV, a plurality of clock signals CLK1 and CLK2, and a gate-off voltage Voff. However, the scanning start signal STV is not input to the sub-gate driver 400R located on the right side unlike the gate drivers 400L and 400R shown in FIG. 4. A switching unit SW is disposed in each of the gate lines G₁-Gₙ close to the sub-gate driver 400R.

The method of repairing defective stage such as j-th stage STj will be described in detail with reference to FIG. 8. For better comprehension and ease of description, the scanning start signal STV, the clock signals CLK1 and CLK2, and the gate-off voltage Voff are not shown. Furthermore, in FIG. 7, portions cut through laser irradiation are indicated by “x” LC and portions shorted by laser irradiation are indicated by “triangle” LS. The main gate driver 400L located on the left side and the sub-gate driver 400R located on the right side are symmetrical to each other. Each of the stages 410L of the main gate driver 400L and each of the stages 410R of the gate driver 400R, which are opposite to the stages 410L, are connected to the same gate lines Gⱼ₋₂-Gⱼ₊₂. As described above, the switching units SW are disposed close to the sub-gate driver 400R. The switching units SW stay turned off during a normal operation and may be turned on, if appropriate. An additional control signal for the operation of the switching units SW may be applied. Unlike the above, the gate lines G₁-Gₙ between the main gate driver 400L and the sub-gate driver 400R may be formed in a disconnected state and may be connected by irradiating necessary portions with a laser. Each of the stages ST(j−2)-ST(j+2) includes a first terminal line TL₁ connected between the switching unit SW and an output terminal OUT1, a second terminal line TL₂ connected to an output terminal OUT2, and signal lines SLⱼ₋₁, SLⱼ, and SLⱼ₊₁ connected to the second terminal line TL₂ and also connected to previous and later stages, respectively.

At this time, the switching unit SW located in the (j−1)-th gate line Gⱼ₋₁ and the switching unit SW located in the j-th gate line Gⱼ are turned on, the terminal lines TL₁ and TL₂ extending from the output terminals OUT1 and OUT2 of the (j−1)-th stage ST(j−1) of the sub-gate driver 400R are cut, and the signal line SLⱼ₋₁ and the gate line Gⱼ₋₁ are shorted. Therefore, a gate output Gout(j−1) is input to a j-th stage STj of the sub-gate driver 400R and operates the stage STj accordingly. In a similar way, the terminal lines TL₁ and TL₂ extending from the output terminals OUT1 and OUT2 of the j-th stage STj of the main gate driver 400L may be cut, and the signal line SLj and the gate line Gⱼ may be shorted. If so, the gate output Gout(j) generated from the j-th stage STj of the sub-gate driver 400L is input to a reset terminal R of the (j−1)-th stage ST(j−1) of the main gate driver 400L and the set terminal S of the (j+1)-th stage ST(j+1), respectively. Meanwhile, since the terminal line TL₂ connected to the output terminal OUT2 of the sub-gate driver 400R is cut, the carry output Cout(j) is not input to the terminal line TL₂. Accordingly, subsequent stages including the (j+1)-th stage ST(j+1) are not operated.

As described above, gate drivers 400L, 400R generate the same output and are connected with gate lines G₁-Gₙ on the left and right sides of the display. It is therefore possible to repair disconnected gate lines G₁-Gₙ without using a laser. Furthermore, switching units SW are included in main gate driver 400L and sub-gate driver 400R so that defects occurring in stage 410L of the main gate driver 400L can be easily repaired. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of pixels respectively including a switching element;
a gate line connected to the switching element; and
first and second gate drivers respectively including a plurality of stages, which are interconnected and sequentially generate output signals,
wherein any one of the stages of the first gate driver and any one of the stages of the second gate driver are connected to the same gate line.

2. The display device of claim 1, wherein the stages of the first and second gate drivers, which are connected to the same gate line, generate outputs at the same time.

3. The display device of claim 2, wherein each of the stages includes a set terminal, a reset terminal, a gate voltage terminal, first and second output terminals, and first and second clock terminals.

4. The display device of claim 3, wherein each of the stages comprises:
a first switching element including a first terminal connected to the first clock terminal, a second terminal connected to a first node, and a third terminal connected to the first output terminal;
a second switching element including first and second terminals commonly connected to the set terminal, and a third terminal connected to the first node;
a third switching element including a first terminal connected to the first node, a second terminal connected to the reset terminal, and a third terminal connected to a gate-off voltage terminal;
a fourth switching element including a first terminal connected to the first node, a second terminal connected to a second node, and a third terminal connected to the gate-off voltage terminal;
a fifth switching element including a first terminal connected to the first output terminal, a second terminal connected to the second node, and a third terminal connected to the gate-off voltage terminal;
a sixth switching element including a first terminal connected to the first output terminal, a second terminal connected to the second clock terminal, and a third terminal connected to the gate-off voltage terminal;
a seventh switching element including a first terminal connected to the second node, a second terminal connected to the first node, and a third terminal connected to the gate-off voltage terminal;
an eighth switching element including a first terminal connected to the first clock terminal, a second terminal connected to the first node, and a third terminal connected to the second output terminal;
a ninth switching element including a first terminal connected to the second output terminal, a second terminal connected to the second clock terminal, and a third terminal connected to the gate-off voltage terminal;
a tenth switching element including a first terminal connected to the second output terminal, a second terminal connected to the second node, and a third terminal connected to the gate-off voltage terminal;
a first capacitor connected between the first clock terminal and the second node;
a second capacitor connected between the first node and the first output terminal; and
a third capacitor connected between the first node and the second output terminal.

5. The display device of claim 4, wherein the first to tenth switching elements are made of amorphous silicon.

6. The display device of claim 5, further comprising:
a display panel unit including the pixels and the signal lines,
wherein the first and second gate drivers are integrated in the display panel unit.

7. The display device of claim 6, further comprising a driving circuit chip mounted in the display panel unit.

8. The display device of claim 7, further comprising:
data lines connected to the pixels;
a data driver that generates a data voltage and applies the data voltage to the data lines; and
a signal controller that generates a control signal for controlling the gate drivers and the data driver.

9. The display device of claim 8, wherein the driving circuit chip includes the data driver and the signal controller.

10. The display device of claim 9, wherein the display device is a liquid crystal display.

11. A display device comprising:
a plurality of pixels respectively including a switching element;
gate lines respectively connected to the switching elements; and
first and second gate drivers respectively including a plurality of first and second stages, which are interconnected and sequentially generate output signals,
wherein any one of the first stages of the first gate driver and any one of the second stages of the second gate driver are connected to the same gate line with the switching element therebetween.

12. The display device of claim 11, wherein in the case that any one of the first stages is a defective stage that cannot generate an output, the second stage connected to the defective stage through the same gate line generates an output.

13. The display device of claim 12, wherein a switching element connected to the gate line between the defective stage and the second stage, and a switching element connected to a previous gate line of the gate line, are turned on at the same time.

14. The display device of claim 13, wherein:
each of the first and second stages includes first and second terminal lines, and a signal line connected to the second terminal line and previous and later stages of each stage; and
the first and second terminal lines of the defective stage are disconnected, a part of the first terminal lines is shorted to the signal line, the first and second terminal lines of a previous stage of the second stage connected by the same gate line as that of the defective stage are disconnected, and a part of the first terminal lines is shorted to the signal line.

15. The display device of claim 14, wherein the second terminal line of the second stage connected to the same gate line as that of the defective stage is disconnected.

16. The display device of claim 11, wherein the display device is a liquid crystal display.
